(19) United States
(12) Patent Application Publication
(10) Pub. No.: US 2004/0047653 A1
(43) Pub. Date: Mar. 11, 2004

(54) Corona chargers having consumer replaceable components

(75) Inventors: Jorge L. Chavez, Spencerport, NY (US); Graham S. Wright, Victor, NY (US); Joseph L. Baker, Rochester, NY (US); Vidanand P. Chand, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/263,983

(22) Filed: Oct. 3, 2002

Related U.S. Application Data
(60) Provisional application No. 60/408,939, filed on Sep. 6, 2002.

(51) Int. Cl. G03G 15/02

(52) U.S. Cl. 399/170; 399/171; 399/172; 250/324

(57) ABSTRACT

A charging device assembly used within a reprographic machine having a hollow shell containing the charging device, an attachment mechanism that fastens the charging device to the hollow shell in a predetermined position, a pair of end covers at either end of the hollow shell and an electrical connector on the shell that is coupled to the charging device. The shell can be conductive or insulative and is formed with features that facilitate easy mounting and removing of the charging device assembly.

### CROSS-REFERENCE TO RELATED APPLICATION

This application claims priority of the U.S. Provisional Application Serial No. 60/408,939, entitled, CORONA CHARGERS HAVING CONSUMER REPLACEABLE COMPONENTS, filed Sep. 6, 2002.

### FIELD OF THE INVENTION

The present invention relates to corona charging devices, and more particularly to customer replacement components for corona chargers.

### BACKGROUND OF THE INVENTION

There are numerous prior art disclosures detailing the use of charging devices within various types of reprographic machines to control the polarity on various elements within the reprographic machine. Charging devices are especially useful in reprographic machines that employ electrostatics to control charge levels, condition image receiving elements as well as various parts of reprographic machines and insure that charges are the intended polarity. Corona chargers used within conventional reprographic machines typically require specially trained field service personal to change the chargers after their intended period of use is completed. In general, a corona charger is a high maintenance device, especially in high end printing devices that generate a high number of prints, and require qualified technicians or field service personal to change the chargers. These high-end printing devices have particular actions items that need to be performed in a highly accurate manner. Actions such as dismounting the charger from the machine, removing covers on the machine or charger assembly, removing the wire used to for the corona charger, cleaning the body charger, putting back the covers or assembly, and mounting the chargers into the machine must be done in a manner that is essentially foolproof. In order to insure that proper maintenance is carried out on these high-end machines, specially trained personnel are typically required. The requirement of specially trained personal can result in significant periods of downtime for the machine, which is an unacceptable loss for the owner/operator of a high-end printing device. To eliminate the need for specially trained personal, a charger assembly is required that can quickly be replaced without requiring adjustments to be made within the charger assembly.

In view of the foregoing discussion, there remains a need within the art for a design that allows the changing of charging devices by the owner/operator in short periods of time without the necessity of specially trained personal. Additionally, there is a need for a mechanical design for charging devices for high end printing machines that uses interchangeable parts.

### SUMMARY OF THE INVENTION

The present invention addresses the aforementioned needs within the prior art by providing a corona-charging device that can quickly be replaced by the user/operator of a reprographic machine without requiring any adjustments in the charger assembly resulting in significant increases in the up time exhibited by the reprographic machine. The up time is the amount of time that the machine is running and, therefore, available to produce high quality prints. Reprographic machines intended to produce large amounts of high quality prints are intended to have high reliability characteristics. The invention addresses these needs by providing a charger in the form of an operator replaceable component (ORC) that focuses on the mechanical aspects of corona and web-charging devices.

The number of actions that the user/operator is required to perform and the difficulty of these actions are minimized by the charging device structure of the present invention. There are certain actions that routinely need to be performed without the necessity of adjustments, and these actions need to be accomplished in a relatively foolproof manner. Actions such as: dismounting the charger from the machine; removing any covers on the body; removing the wire corona; cleaning the body charger, putting the covers back on to the charger body; and mounting the chargers into the machine, are critical to increasing the amount of up time of a reprographic machine.

The invention teaches a charging apparatus that can be used on a system having multiple charging components. In the preferred embodiment, there are numerous web-charging components including charging devices that: tack down the receiver elements to the web; control potential levels between modules; detack the receiver elements from the web; and conditioner the web to be at a predetermined potential level. The invention provides these charging devices in an assembly that can be serviced by the user without requiring special tools.

The charger assembly of the invention provides every feature that is considered critical within a charging device mechanical assembly, and comprises a single operator replaceable component (ORC). The mechanical assembly for the charging device includes the critical parts having the necessary measurements and adjustments already made to provide for the correct spatial configurations with minimal amounts of down time for the reprographic equipment. These critical distances include: the spacing between corona wires; ensuring equal distance between the web and the corona wires; the size of the gap between the wire and the ground plane; and the length of exposure wire among others.

In the preferred embodiment, the charger assembly is employed in a high-end digital printing device that uses charging devices to control potential levels throughout the system. High-end printing devices inherently use multiple charging devices and for high-end color, printing devices will require more charging devices. The mechanical assembly of the invention is used as an ORC for every charging device in the system, resulting in a more reliable reprographic machine.

The invention envisions sliding the charging device assemblies out of their operating positions within the digital printing device by performing actions that entail removal of the assembly. It should be noted that in performing the actions necessary to remove the charger assembly from the digital printing device, there is no need to remove any bracket or to unlock the charger from the rail. Additionally, the removal of a high voltage connector is invisible to the customer (blind mate HV connection). To disassemble of the components of a charger, the front and rear covers have snap features that wrap around the end of the body chargers and do not require the use of any tools to remove. The removal of the corona wire is simplified for easy removal by first removing the tension of the wire and then removing the wire form the assembly. The disassembly of the grid is accomplished by sliding the grid out from the charger body.

The invention has the advantage in that the same parts can be used in several charger applications. The same charger body can be used in the intermodule chargers, detack chargers, conditioner chargers without a grid, and conditioner chargers with a grid. The same rear covers can be used in all chargers bodies (intermodule, detack, and conditioners). The corona wires are the same in all chargers. Just one corona wire length can be used in numerous applications. The front end is the same in all chargers. The interchangeability of parts avoids confusion in inventory and reduces the number of parts that must be inventoried.

Additional advantages result from the ability to precisely locate the web between conditioner chargers and their associated grids.

### BRIEF DESCRIPTION OF THE DRAWINGS

FIG. 1 is an illustration of a digital printer the employs the charging devices of the invention;

FIG. 2a is an exploded view of the topside of the charging device assembly of the invention;

FIG. 2b is an exploded view of the bottom side of the charging device assembly of the invention;

FIG. 2c is a view of the charging device assembly of the invention with a grid;

FIG. 2d is a view of a mounting device that can be used with the charging device assembly of the invention;

FIG. 2e is a view of the charging device assembly of the invention with a grid;

FIG. 2f is a view of a mounting device that can be used with the charging device assembly of the invention; and

FIG. 3 is a view of a conditioning charger using four charging device assemblies of the invention, two of the assemblies using grids.

### DETAILED DESCRIPTION OF THE INVENTION

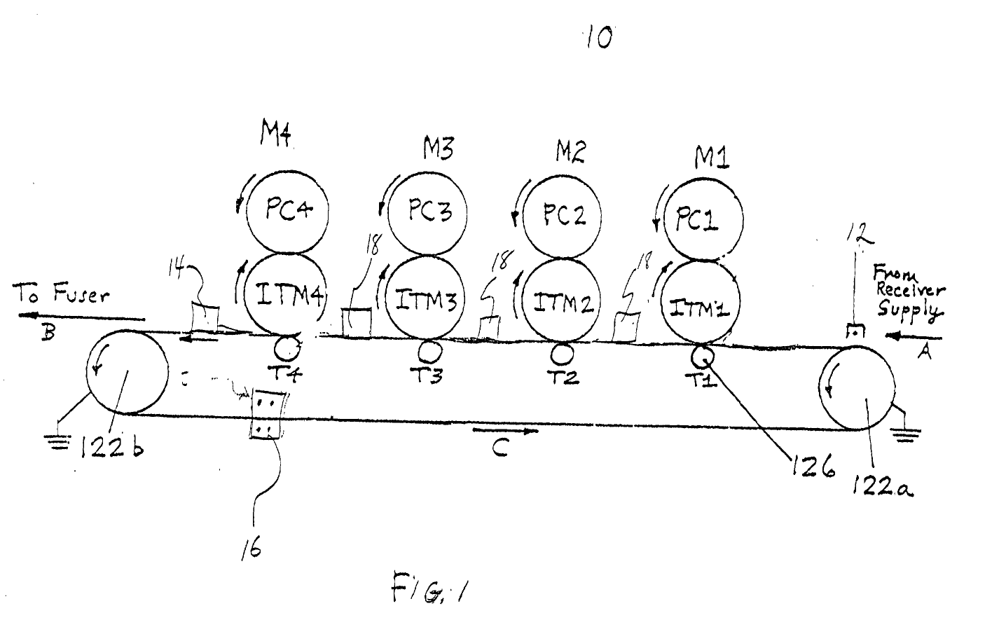

Referring to FIG. 1, the charger assembly of the invention is employed on a digital printer 10 in multiple locations. The digital printer 10, preferably has four modules M1, M2, M3, M4 each of which is responsible for printing a single color. Each of the modules M1, M2, M3, M4 has a photoconductive member, respectively indicated as P1, P2, P3, P4, an intermediate transfer member, respectively indicated as ITM1, ITM2, ITM3, ITM4, and a transfer roller respectfully indicated T1, T2, T3, T4. FIG. 1 illustrates a printer 10 that is used by the preferred embodiment of the invention. It will be readily understood, to those skilled in the art that the charger assembly of the invention can be used for different printer configurations that are too numerous to illustrate. The charger assembly as envisioned by the invention comprises a complete charging device that can be employed in multiple instances. Digital printer 10 contains various charger assemblies as envisioned by the present invention that are placed at different areas within printer 10. The chargers shown in FIG. 1 are tackdown charger 12, detack charger 14, conditioner charger 16, and intermodule chargers 18. The charging devices that are employed in the digital printer 10 will be either AC or DC based chargers. The tackdown charger is DC chargers while the detack, conditioner and intermodule chargers are AC based. The function of the tackdown charger 12 is to place a charge on the receiver elements so that they adhere to the Web 5. The function of the detack charger 14 within the preferred embodiment is primarily to detach that image receiver elements from the Web 5. Conditioner charger 16 operates on the electrostatic properties of Web 5 so that they are at a predetermined potential level. The function of the intermodule charger 18 is to compensate for the changes in potential levels resulting from the printing operations of each of the electrophotographic stations.

The charger assembly of the invention is intended facilitate multiple charger applications and allow the same parts to be used in several charger applications. These applications are distributed around the printer 10. The spatial configurations surrounding each of the corona wires in the various applications is not be the same. Accordingly, the printer 10 of the preferred embodiment is a NexPress 2100 that is designed to accommodate the charger assembly of the invention in different locations. The capability of implementing multiple ORC devices within a machine having interchangeable parts provides substantial advantages from the point of view of inventory management at the customer site. The number of spare parts that are required to be kept in inventory at a user location are minimized by employing a charger designs that use the same parts in the corresponding charger applications as describe herein.

An advantage of the invention is the simplicity of the maintenance process for web chargers. The design of the invention focuses on the maintenance process in terms of events the user needs to act upon and the user response to these events without requiring specialized tools.

The tackdown charger 12 assembly comprises a metal shell with end covers that contain a corona wire that is easy to remove. The corona wires employed are on the order of 0.005″ and are intended to operate at 8 KV and 13 μA.

The detack charger 14 assembly is similar in that of the conditioner or intermodule charger 12 assembly with a plastic shell, a pair of end covers; and a replaceable corona wire. The corona wire is on the order of 0.005″ and intended to accommodate 15 KVpp at 100 μA. The corona wire is designed to be easy to remove and attached to a ground plane, which in the preferred embodiment, is the ski.

The conditioner charger 16 features numerous assemblies that can be considered ORC devices. In the preferred embodiment there are four corona wires within the conditioner charger 16, each of the corona wires is on the order of about 0.127 (0.005″) thick and operates at a potential of 15 KVpp drawing current of about 300-600 μA. The assemblies that house the corona wires within the conditioner charger 16 of the present invention, additionally, will employ plastic shells, end covers to prevent arcing, easy to remove corona wires, blind mate HV connector for the chargers, blind mate ground connector for grids, and slide in plastic extrusion elements. The conditioner charger 16 of the invention envisions that grids will be employed on predetermined corona wires within the conditioner charger 16. Most of the grids currently in the industry use a thin material (0.127 mm.) and apply tension to it. However, tension on the grid can result in flatness on the surface of the grid. Additionally, there are more parts added to the system by the tension mechanism. The preferred embodiment employs a grid that is just one part using 0.61 mm thick material, photo-etching the desired geometry and then fastening the grid to the charger body by snapping on it (as will be discussed further in greater detail). The invention controls the grid distance is tightly controlled to four tabs that are in reference to the corona wire location, this will be discussed more in detail below. The grid snaps around the four tabs by means of a cantilever beam member resulting in only a small deformation on the beam member, which is considered advantageous. After the first insertion of a grid onto a beam member, the grid does not present any substantial resistance force during insertion into the four tabs. The Grid is considered an ORC which has a limited life because contamination and other issues.

It should be noted that there are certain critical requirements for the conditioner charger 16. The location of the center of the Web between the chargers (preferably with grids) is considered critical and is controlled by the use of two skis. The skis allow the positional tolerance of chargers to be greatly reduced. Web Precisely located between chargers and grids. The only intention for the skis is to precisely locate the web between the chargers and grids. Once the skis are touching the web, the web path has been defined and the chargers are located in reference to the skis. The touching of the skis against the web can be loosely controlled and as long as the web touches the skis, the process is effective.

The intermodule charger 18 features a charger assembly that is an ORC in itself employing one 0.127 (0.005″) corona wires operating at about 15 KVpp, drawing current on the order of about 5-20 μADC. The intermodule charger 18 has a plastic shell and end covers to prevent arcing.

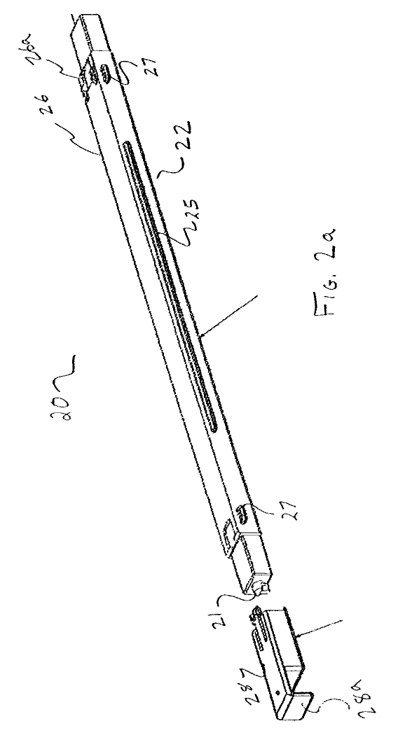

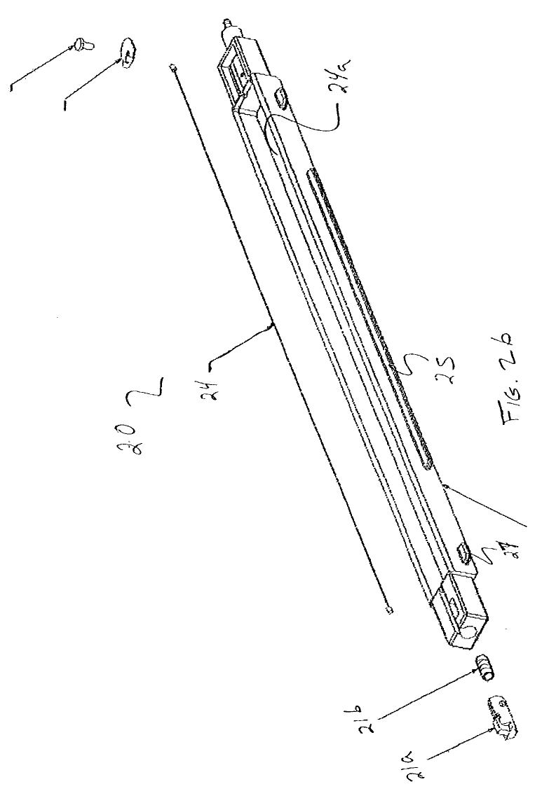

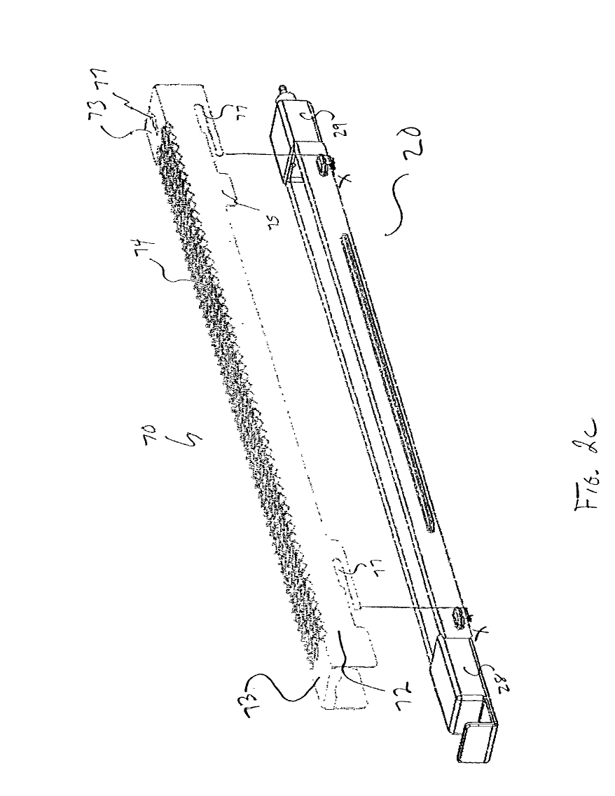

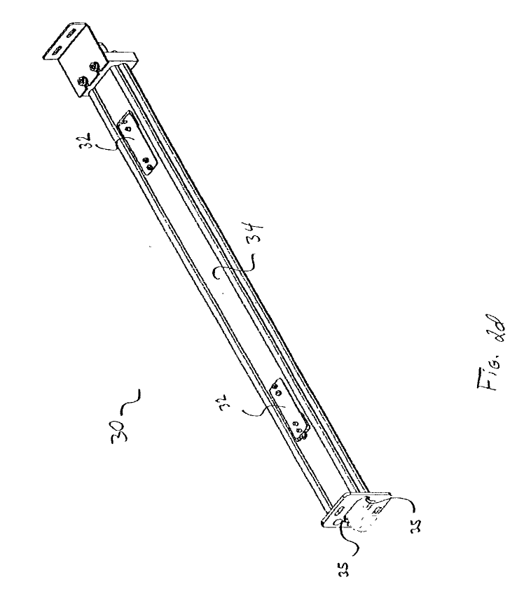

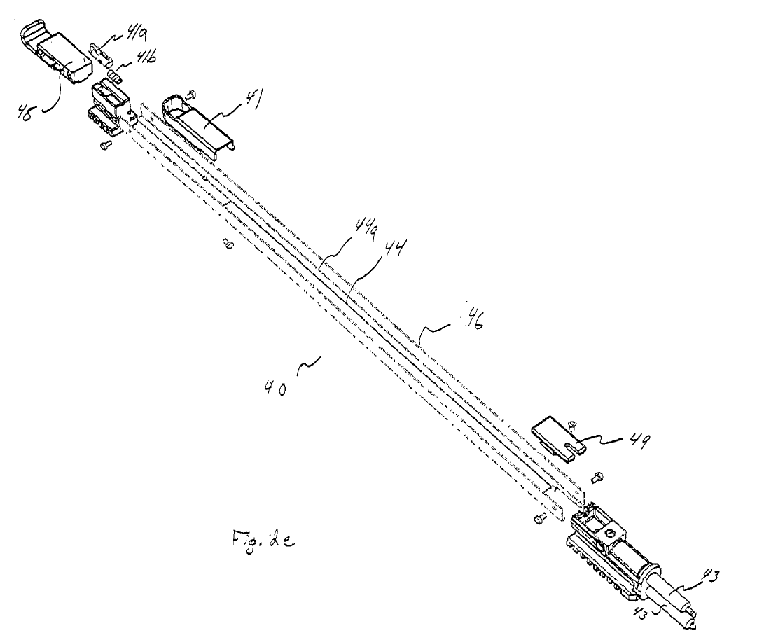

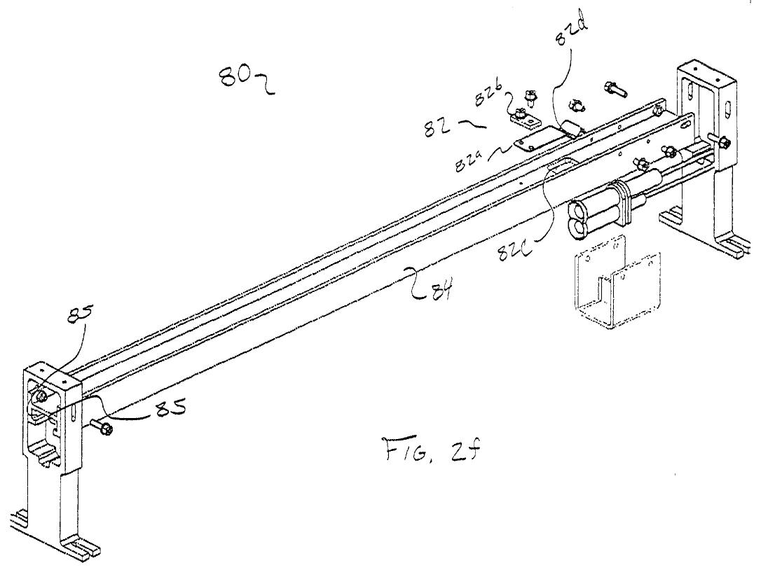

FIG. 2a and FIG. 2b are partially exploded perspective views of the top and bottom sides, respectively, of the charger assembly 20 of the invention. FIG. 2a and FIG. 2b illustrate assemblies of chargers that are the AC type, however, DC type chargers will have similar configurations differing essentially only in materials. The charger assembly 20 includes outer shell body 26 with front and rear covers 28, 29. As seen in FIG. 2b, charging device 24 mounted within a hollow cavity 24a. The charging device 24 is secured into the shell body 26 by securing mechanism 21; preferably, plunger 21a and spring 21b are used as securing mechanism 21. The outer shell body 26 for AC chargers is preferably made from an injection molded plastic material that is formed with side rails 25 and ears 24 that are used to position and fasten the charger assembly 20 in its proper position within digital printer 10. The outer shell body 26 is configured with AC Pin 23 as an electrical connector such that the charging device 24 is electrically coupled to AC Pin 23, which provides power to charging device 24 when plugged into a mating receptacle (not shown). Sub-assembly 22 comprises the outer shell body 26 with the charging device 24 mounted, therein, such that it is coupled to AC Pin 23. The sub-assembly together with front and rear covers 28, 29 form much of the charger assembly 20. Additional items on charger assembly 20 will be discussed more below.

A pin at the end of the charger assembly (preferably straight out from the assembly body) couples to the charging device to a high voltage source. Sliding the pin in connects to the high voltage receptacle, whereas sliding the pin put disconnects from the high voltage receptacle. The invention envisions numerous types of couplings of high voltage source to the charging device and it should be understood that the pin is the preferred manner of applying high voltage to the charging device. The charging device 24 is a corona wire that is removed by depressing a plunger.

The invention envisions a charger assembly 20 that can be disassembled into its basic components. The front cover 28, rear cover 29 and outer shell body 26 are preferably made of plastic that snap into place and can be easily removed. The plastic front and rear covers 28, 29 snap into corresponding features on the body of the charger sub-assembly 22 by using the cantilever beam methodology wherein the plastic material will flex with the application of a relatively small amount of force.

FIG. 2c illustrates a grid with the charger assembly that would be employed within the conditioner charger 16 as previously discussed. The assembly shown in FIG. 2c does not require tension, therefore, it does not suffer from the prior art problem of on the surface of the grid. Also, fewer parts are required by the assembly shown if FIG. 2c than in prior art grid devices. The preferred embodiment employs a grid 70 that is formed as a single piece out of a conductive material that is 0.61 mm thick. Preferably, the material used to make grid 70 is a steel alloy, or stainless steel. Other material will be readily apparent to those skilled in the art. The preferred method of manufacturing the grid is by using conventional photo-etching processes to obtain the desired geometry. Steel based materials are preferred because these materials are conductive, photo-etch well and are not expensive. It will be readily apparent that other material can be used. It is also envisioned that other manufacturing processes can be used to form grid 70 and that these other processes will be readily apparent those skilled in the art. During the manufacturing process, features are formed on the grid 70. Among the features that are formed on grid 70 are those features that assist in fastening the grid 70 to the charger device assembly 20 and enable the grid 70 to be simply snapped into place on the charger device assembly. The invention enables a tight control of the distances associated with grid 70 because the four tabs 27 provide a reference to location of the corona wire. The grid 70 snaps around the four tabs 27 by forming four slots 77 within grid 70 such that tabs 27 can be inserted into slots 77 by moving grid 70 by reference to arrow X. To remove the grid 70 from the sub-assembly 22 a force in exerted in a direction similar to arrow X. To insert the grid 70 onto the sub-assembly, a force is exerted in a direction opposite that of arrow X. Slots 77 are fashioned to engage tabs 27 and secure grid 70 to the charger device assembly 20 in a removable manner. The assembly illustrated in FIG. 2c does not result in the exertion of a large tensile force on the cantilever beam structure of sub-assembly 22. The structure of grid 70 can itself be viewed as a beam. An advantage of the assembly shown in FIG. 2c is that the lack of tension required results in only a small deformation on the beam structure of sub-assembly 22. The grid 70 needs to be able to lie flat, within a plane, once placed on the sub-assembly. The grid 70 by itself removed from the plane can be either rigid or flexible. Once a grid 70 has been inserted on the charger device assembly 20, the four tabs 27 easily slide into slots 77 and the grid itself will fit onto the sub-assembly 22. The assembled charger can then be inserted into the mounting device without any resistance from the grid 70 during insertion. The grid 70 is considered an ORC which has a limited life because contamination and other issues. Thus, the ability to remove grid 70 and replace or clean it is an important feature towards keeping the printer 10 up and running producing high quality prints. The grid 70 members include both a gridded portion 74 and a non-gridded portion 73 that are formed in such a manner that, preferably, the length of the gridded portion 74 will be long enough to extend beyond the boundary area between the end caps 28, 29 with sub-assembly 22 when the grid 70 is placed in position on the charger assembly 20 thereby leaving a gridded area above this boundry. The grid includes an arrow shaped cut out 77 for reference in guiding the completed assembly into the intended supporting structure. Once assembled, the side wall 72 of grid 70 will overlap the side wall of the charger device assembly 20 in such a manner that the features formed on the side wall 72 of grid 70 will surrounds and almost touch the side rail 25 of charger device assembly 20.

FIG. 2d illustrates an exploded view of a typical charger frame 30. The procedure for dismounting the charger assembly 20 from printer 10 is designed to be a simplified procedure for allowing the operator to perform the task of removing and replacing the charging device 24. The charger assembly 20 with charging device 24 (preferably a corona wire) rests within the outer shell body 26 that provides an enclosure for charging device 24. The charger assembly 20 is placed into the charger frame 30 such that the charger assembly 20 is biased against charger frame 30. The charger assembly 20 is placed into rail 34 such that side rails 25 fit within rail slots 35 slide into position. The preferred embodiment uses mechanical biasing forces to press the charger assembly 20 against one side of the charger frame 30 by placing at least one push spring assembly 32 on the charger assembly 20. As seen in FIG. 2d, one spring assembly 32 is shown towards the back of rail 34, but preferably, another spring assembly (not shown) is located towards the front of rail 34. As previously discussed, there are four tabs 27 on the sub- 22 that fit inside the rail slots 35 of rail 34 to position the charging device 24 within the charger frame 30. Each push spring assembly 32 creates a mechanical force that presses the four tabs 27 against the bottom of rail slots 35 of rail 34, thus providing the desired positioning of the charging device 24 within the charger frame 30. The mechanical bias provided by push spring assembly 32 is guarantees that the charging device 24 is placed in the same position every time the charger assembly 20 is slide in and out of the charge frame 30. The mechanical biasing force provided by the push spring assemblies 32 is sufficient to insure that charging device 24 is located in the desired position during operation of printer 10 but small enough so that removal of the charger assembly 20 by the operator is accomplished by simply pulling on handle portion 28a of charger assembly 20. The operator needs only to pull on the handle portion 28a of front cover 28 to remove the charger assembly 20 from the charger frame 30.

FIG. 2e is a partially exploded perspective view of charger assembly 40 of the invention. FIG. 2e illustrates an assembly of a DC type charger that has a similar configuration to the chargers shown in FIG. 2a and FIG. 2b, differing essentially only in materials. The charger assembly 40 includes outer shell body 46 with front and rear covers 48, 49. As seen in FIG. 2b, charging device 44 mounted within a hollow cavity 44a. The charging device 44 is secured into the shell body 46 by securing mechanism 41; preferably, plunger 41a and spring 41b are used as securing mechanism 41. The outer shell body 46 for DC chargers is preferably made from a conductive material, such as metal, that is a more rigid material than used to form the shell body to the AC chargers previously discussed. Outer shell 46 may be formed with side rails 45 and ears 47 that are used to position and fasten the charger assembly 40 in its proper position within digital printer 10, however, ear 47 are optional, although rail 45 are preferable. The outer shell body 46 is configured with DC Pins 43 coupled to charging device 44 to to provide power to charging device 44 when plugged into a mating receptacle (not shown). Sub-assembly 42 comprises the outer shell body 46 with the charging device 44 mounted, therein, such that it is coupled to DC Pins 43. The sub-assembly together with front and rear covers 48, 49 form much of the charger assembly 40. Additional items on charger assembly 40 will be discussed more below.

A pin at the end of the charger assembly (preferably straight out from the assembly body) couples to the charging device to a high voltage source. Sliding the pin in connects to the high voltage receptacle, whereas sliding the pin put disconnects from the high voltage receptacle. The invention envisions numerous types of couplings of high voltage source to the charging device and it should be understood that the pin is the preferred manner of applying high voltage to the charging device. The charging device 44 is a corona wire that is removed by depressing a plunger.

FIG. 2f illustrates a typical charger frame 80 for use with charger assembly 40. The procedure for dismounting the charger assembly 40 from printer 10 is designed to be a simplified procedure for allowing the operator to perform the task of removing and replacing the charging device 44. The charger assembly 40 with charging device 44 (preferably a corona wire) rests within the outer shell body 46 that provides an enclosure for charging device 44. The charger assembly 40 is placed into the charger frame 80 such that the charger assembly 40 is biased against charger frame 80. The charger assembly 40 is placed into rail 84 such that side rails 45 fit within rail slots 85 slide into position. The preferred embodiment uses mechanical biasing forces to press the charger assembly 40 against one side of the charger frame 80 by placing at least one push spring assembly 82 on the charger assembly 40. As seen in FIG. 2f, one spring assembly 82 is shown towards the back of rail 84. The push spring assembly 82 creates a mechanical force that presses the rail slots 85 of rail 84, thus providing the desired positioning of the charging device 44 within the charger frame 80. The push spring assembly 82 includes flat-springs 82a and spacer 82b that are mounted on rail 84 and engage indentations 46a within the outer shell body 46. Aperture 82c is provided in rail 84 so that bent portion 82d protrudes through aperture 82c. The side rails 45 of charger assembly 20 can then be slid along rail slots 85 of rails 84 and allow bent portion 82d of flat-spring 82a to engage indentation 26a. The mechanical bias provided by push spring assembly 82 is guarantees that the charging device 24 is placed in the same position every time the charger assembly 20 is slide in and out of the charge frame 80. The mechanical biasing force provided by the push spring assemblies 82 is sufficient to insure that charging device 24 is located in the desired position during operation of printer 10 but small enough so that removal of the charger assembly 20 by the operator is accomplished by simply pulling on handle portion 28a of charger assembly 20. The operator needs only to pull on the handle portion 28a of front cover 28 to remove the charger assembly 20 from the charger frame 80.

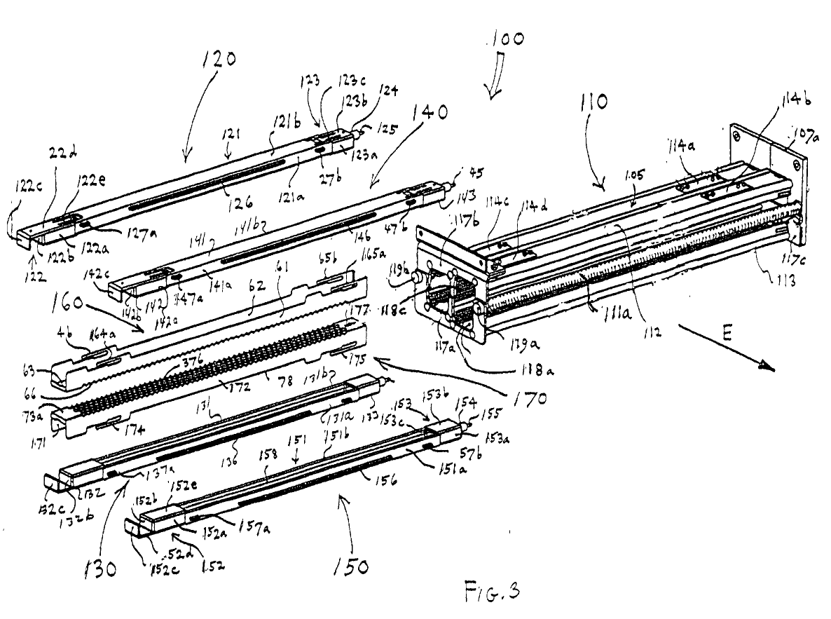

FIG. 3 is an exploded view showing a web conditioning charging station employ charging device assemblies as envisioned by the invention, generally designated as 100, having a supporting structure 110 and charging devices 120, 130, 140, and 150 designed in accordance with the invention. Charging devices 120 and 130 are first stage corona chargers. Charging devices 140 and 150 are second stage corona chargers. In the second stage, the charging devices 140, 150 are respectively associated with grid members 160, 170. The charging devices 120, 130, 140, and 150 are made to be substantially the same as one another in accordance with the modular concepts of the invention. Accordingly, grid members 160 and 170 are also made to be the same piece, within manufacturing tolerances. During operation of the digital printer 10, the transport web passes through supporting structure 110 in a direction indicated by arrow E.

The charging devices 120, 130, 140, 150 have respective shells 121, 131, 141, 151 with respective sidewalls 121a, 131a, 141a, 151a and respective walls 121b, 131b, 141b, 151b. Charging devices 120, 130, 140, 150 have removable end caps 122, 132, 142, 152, which cover the respective end walls (not shown) of the operative portion of their shell 121, 131, 141, 151. Removable end caps 122, 132, 142, 152 are preferably made out of an insulative material. The end caps 122, 132, 142, 152 include: side walls 122a, 132a, 142a, 152a; end walls 122b, 132b 142b, 152b; and handles 122c, 132c, 142c, 152c which provide for mounting and removing charging devices 120, 130, 140, 150 within supporting structure 110. Insulative end caps 123, 133, 143, 153 cover the other ends (not shown) of charging devices 120, 130, 140, 150. Each of the insulative end caps 123, 133, 143, 153 is preferably molded as a single piece that is made to be removable from their respective shell 121, 131, 141, 151.

Charging device 150 is seen in a bottom side view illustrating corona wire 158 traversing the length of the open portion of charging device 150. As can be seen, the interior of charging device 150 is hollow with the open portion of charging device 150 defined by removable end cap 152 and insulative end cap 153 covering a second end wall (not visible) of shell 151. Wall 152e of end cap 152 of charging device 150 covers a portion (not visible) of the corona wire 158 which is held under tension by a spring loaded mechanism (not illustrated), the spring loaded mechanism also being covered by wall 152e, and similarly for the other charging devices. End cap 153 includes sidewalls 153a and 153c, and a wall 153b that covers the other end of wire 158, which end of the wire is attached to a metal pin 155. The pin 155 is surrounded by an insulative coating 154, which insulative coating is molded to the corresponding end wall (not visible) of shell 151. Pin 155 and coating 154 pass with clearance through a hole in the end wall of end cap 153 (end wall and hole not visible). The corona wire 158 has a preferred diameter of 0.0033 inches, and is preferably made of tungsten. The shells, e.g., shell 121, are preferably made of Mindel B-430 plastic. Shell side walls, 151a, b are about 2 mm thick, and shell back walls, e.g., back wall 121b, are about 2 mm thick. The end caps 122, 123 are preferably made of flame retarded PET sold under the trade name Valox 310SEO. Connector pin 125 is preferably made of a brass alloy. Other suitable materials can be substituted to make the shells, end caps, corona wires, or pins as will be readily apparent to those skilled in the art.

Charging device 120 is shown in top and side view illustrating insulative end cap 123 and a top piece 122d which includes a spring portion 122e. The spring portion 122e snaps into a shallow outer recess in wall 121b (recess not illustrated) for purpose of attaching end cap 122 to shell 121. By lifting spring portion 122e, removable end cap 122 can be removed. End cap 123, which is similar in all respects to end cap 153, includes a sidewall 123a and a top piece 123b, which includes a spring portion 123c. The spring portion 123c snaps into a shallow outer recess in wall 121b (recess not illustrated) for purpose of attaching end cap 123 to shell 121. By lifting spring portion 123c, removable end cap 123 may be removed. Pin 125 and pin coating 124 pass with clearance through a hole in the end wall of end cap 123 (end wall and hole not visible). Each of charging devices 120, 130, 140, and 150 is thus similarly provided with a dielectric shell, a tensioned corona wire, and two insulative end caps covering the ends of each corona wire, the opening between end caps defining the operational charging length of each such corona wire. The operational charging length of each of these corona wires is 366.5 mm, but may be any suitable length as required.

Each of charging devices 120, 130, 140, 150 is provided with symmetrically located side rails 126, 136, 146, 156, one side rail on the outer face of each side wall. The side rails 126, 136, 146, 156 are used for the purpose of mounting and dismounting the charging devices 120, 130, 140, 150 within the supporting structure 110 and are preferably molded as portions of the shell during shell manufacture.

The charging devices 120, 130, 140, 150 are also provided with ears on an outer surface. The ears are generally referred to as 127a, 127b, respectively for the front and rear areas of charging device 120. In a similar manner ears 137a, 137b for the front and rear areas of charging device 130, 147a, 147b for charging device 140, and 157a, 157b for charging device 150. The ears are preferably molded as part of the shell during the manufacturing process such that they exist on both sides of the front and rear of the shell and mate with slots or apertures that are within a mounting mechanism for the charging devices. The ears serve the dual functions of mounting/dismounting the charging devices from the supporting structure 110 and providing a mechanism for attaching the grid members to the charging devices if desired. Within the web conditioning charging station 100, the second stage preferably employs grids that are removably secured to the second stage charging device 140 by clips 164a and 165a which respectively mate with ears 147a, 147b. In a similar manner, clips 174, 175 on grid member 170 removably secure ears 157a, 157b on second stage charging device 150, and two clips (not visible) on the outer face of wall 151b removably secure to two ears (not visible) to the outer face of wall 151b.

The grid members include both a gridded portion and a non-gridded portion such that the gridded portions will lie above the end caps when the grid member is in position on the charging device. The grid members are preferably made of stainless steel. Grid 170 includes a cut out 177 from area 173 that is arrow shaped for guiding the assembled second stage charger into supporting structure 110. Each grid member preferably has a cut out that assists in guiding the charging devices 140, 150 in the second stage into the supporting structure. With the second stage chargers assembled, the sidewalls of the grid members overlap the sidewalls of the shells to a considerable extent. Thus, side wall 172 of grid member 170 overlaps side wall 151a of the shell of charging device 150, with the lower edge portion of side wall 172 almost touching side rail 156, and similarly for the corresponding lower edge portion (not visible) of side wall 171. During operation of the second stage chargers with the grid members grounded, the overlapping sidewalls of the grid members provide advantages by acting to enhance the efficiency of the chargers.

Supporting structure 110 includes two end plates at either end to provide support for support elements 105, 106, 112, 113. End plates 117a, 117b are at a first end, and end plates 107a, 117c at a second end provide support for extruded elements 105, 106, 112, 113. The extruded support elements 105, 106, 112, 113 are manufactured to be essentially identical. Preferably, support elements 105, 106, 112, 113 are made from a metal such as extruded aluminum. Support elements 105, 106, 112, 113 are held in place by screws into end plates 117b and 107a. End plates 117a and 117b are preferably made of a metal material, such as stainless steel. End plates 107a and 117c are preferably made of a hard material, preferably an insulating plastic or dielectric polymeric material. The interior lengths of the support elements 105, 106, 112, 113 have sidewalls containing longitudinal tracks for purpose of supporting charging devices. The charging devices 120, 130, 140, 150 are supported in the tracks of supporting structure 110 by the rails and the ears sliding in the pairs of longitudinal tracks included in support elements 105, 106, 112, 113.

The four extruded support elements 105, 106, 112, 113 each includes two steel leaf spring members for holding their respective charging devices 120, 130, 140, 150 securely in place within support member 110. Thus element 105 includes spring members 114a and 114c, and element 112 includes spring members 114b and 114d. The spring members are preferably fastened by screws however, it will be readily apparent to those skilled in the relevant art that other fastening devices such as rivets, bolts or adhesives could be used in place of screws.

The end plates 107a and 117c are preferably made of a strong, electrically insulating material and partially coated on their inner surfaces by a conductive screening material in order to reduce electromagnetic interference (EMI) from the corona charger high voltage wires. Preferably, end plates 107a and 117c are made of a flame retarded polyphenylene oxide sold under the tradename Noryl EN185. To provide partial coatings of conductive screening material on the inner surfaces of these end plates, a copper foil tape, sold under the tradename CHO-FOIL available from the Chomerics Corporation, may be applied. Most of the inner surface of each end plate is covered by the conductive tape in such manner as to avoid electrical contact or shorting to high voltage components, the conductive portions of the tape being preferably grounded. Alternatively, the conductive EMI shielding may be applied to the end plates 107a and 117c by other suitable means, such as, by vacuum evaporation, or conductive ink, or any other conventional manner of placing thin coatings.

The extruded aluminum support elements 105, 106, 112, 113 are electrically grounded, as are grid members 160, 170. Each of the grid members 160 and 170 is grounded, within the preferred embodiment; via metal spring clips embedded between the longitudinal tracks such as tracks 118a and 118c of the second stage support elements (metal spring clips not illustrated).

A downstream constraint ski member 111a is included in supporting structure 110 for the purpose of controlling and positioning the transport web through WCCS 100. A similar upstream constraint ski member 111b (not shown) in FIG. 3, is also used in conjunction with downstream constraint ski member 11a to control the web position. The constraint ski members 111a,b provide tension on the transport web as it passes through WCCS allows a more efficient charge to be placed on the web by charging devices 120, 130, 140, 150. The constraint ski members 11a, b are preferably made of highly polished stainless steel cylindrically shaped rods that are permanently attached at both ends to end plates 117b and 107a.

The supporting structure 110 is disassembled into an upper section and a lower section by unscrewing and removing the thumbscrews 119a, b. The upper section of supporting structure 110 includes the end plates 117c and 107a, the first stage support element 105, the second stage support element 112, as well as the downstream ski member 11a and its upstream counterpart 111b. The lower section includes end plates 117a and 117c, as well as the second stage support element 113 and its first stage counterpart (not shown). Removal of thumbscrews 119a, b allows the entire lower section of supporting structure 110 to be slid off the pins 107a, b and separated from the upper section. The separation of the upper and lower sections of supporting structure 110 can be accomplished with or without the first and second stage chargers in place. The removal of the lower section of supporting structure 110 provides access to the transport web, such as when it is necessary to replace a worn or damaged web. Therefore, it is not necessary to disturb upper section of supporting structure 110 during the installation of a new transport web and the entire conditioning charging station 100 is restored to a proper operating position, quickly and easily while maintaining high reliability. As previously stated, the charging devices 120, 130, 140, 150 can be in place during disassembly of supporting structure 110. If desired the charging devices 120, 130, 140, 150 can be easily removed by simply pulling on the handle portions.

As illustrated by FIG. 3, the preferred web conditioning charging station of the invention embodies fixed spacing between each of the first and second stage chargers and between the chargers and either side of the transport web passing through the web conditioning charging station. Moreover, the preferred web conditioning charging station also has predetermined, accurate, fixed spacing between the two corona wires included in the first-stage chargers, as well as predetermined, accurate, fixed spacing between the two grids of the grid members included in the second-stage chargers. However, the as-manufactured wire-to-wire separation provided in the first stage is typically optimized for a given speed of motion of the transport web, and different as-manufactured wire-to-wire separations may be appropriate for different web speeds. Similarly, the as-manufactured grid-to-grid separation provided in the second stage is typically optimized for a given speed of motion of the transport web, and different as-manufactured grid-to-grid separations may be appropriate for different web speeds. Thus, web conditioning charging stations may be manufactured with differing fixed geometries for different web speeds.

Moreover, although not included in the web conditioning charging station illustrated in FIG. 3 one or more mechanisms (not illustrated) may alternatively be provided for allowing adjustment of the first stage and/or second stage spacing without requiring removal of the web conditioning charging station from the printer 10. Such mechanisms may include, for example, screw devices with verniers, such as micrometers.

The foregoing description details the embodiments most preferred by the inventors to which variations will be readily apparent to those skilled in the art, accordingly, the score of the invention should be measured by the appended claims.

Parts List

| | |
|---|---|
| 10 | printer |
| 12 | tackdown charger |
| 14 | detack charger |
| 16 | conditioner charger |
| 18 | intermodule charger |
| 20 | charger assembly |
| 21 | securing mechanism |
| 21a | plunger |
| 21b | spring |
| 22 | sub-assembly |
| 23 | AC pin |
| 24 | charging device |
| 25 | side rails |
| 26 | out shell body |
| 26a | indentation |
| 27 | tabs |
| 28 | front cover |
| 28a | handle portion |
| 29 | rear cover |
| 30 | charger frame |
| 32 | push spring assemblies |
| 34 | rail |
| 35 | rail slots |
| 40 | charger assembly |
| 41 | securing mechanism |
| 42 | sub-assembly |
| 43 | DC pins |
| 44 | charging device |
| 45 | side rails |
| 46 | out shell body |
| 48 | front cover |
| 49 | rear cover |
| 70 | grid |
| 80 | charger frame |
| 82 | push spring assemblies |
| 82a | flat springs |
| 82b | spacer |
| 82c | aperture |
| 82d | bent portion |
| 84 | rail |
| 85 | rail slots |
| 105 | support element |
| 106 | support element |
| 107a | end plate |
| 110 | supporting structure |
| 111 | ski member |
| 111a | constraint ski member |
| 111b | constraint ski member |
| 112 | support element |
| 113 | support element |
| 117c | end plate |
| 118a | track |
| 118c | track |
| 119a | thumb screw |
| 119b | thumb screw |
| 120 | charging devices |
| 121 | shell |
| 121a | side-wall |
| 122 | end cap |
| 122a | side wall |
| 122b | end wall |
| 122c | handle |
| 123 | end cap |
| 126 | side rails |
| 127a | ear |
| 127b | ear |
| 130 | charging devices |
| 131 | shell |
| 131a | side-wall |
| 132 | end cap |
| 132a | side wall |
| 132b | end wall |
| 132c | handle |
| 133 | end cap |
| 136 | side rails |
| 137a | ear |
| 137b | ear |
| 140 | charging devices |
| 141 | shell |
| 141a | side-wall |
| 142 | end cap |
| 142a | side wall |
| 142b | end wall |
| 142c | handle |
| 143 | end cap |
| 146 | side rails |
| 147a | ear |
| 147b | ear |
| 150 | charging devices |
| 151 | shell |
| 151a | side-wall |
| 151b | side-wall |
| 152 | end cap |
| 152a | side wall |
| 152b | end wall |
| 152c | handle |
| 153 | end cap |
| 153a | side wall |
| 153b | wall |
| 153c | side wall |
| 155 | pin |
| 156 | side rails |
| 157a | ear |
| 157b | ear |
| 158 | wire |
| 160 | grid member |
| 170 | grid member |
| 171 | side wall |
| 172 | side wall |
| 173 | area |
| 174 | clip |
| 175 | clip |
| 177 | cut out |

What is claimed is:

1. A charging device assembly to be placed into a mount and used within a reprographic machine comprising:
a hollow shell containing said charging device;
an attachment mechanism that fastens said charging device to said hollow shell in a predetermined position;
at least one end cover to said assembly that mates with said hollow shell; and
an electrical connector electrically coupled to said charging device.

2. The assembly of claim 1, wherein said hollow shell is an insulative material.

3. The assembly of claim 2, wherein said insulative material is a plastic.

4. The assembly of claim 1, wherein said hollow material is a conductive material.

5. The assembly of claim 4, wherein said conductive material is extruded aluminum.

6. The assembly of claim 1, further comprising a ground plane.

7. The assembly of claim 1, wherein said at least one end cover further comprises a pair of end covers that mate with opposite ends of said hollow shell.

8. The assembly of claim 1, wherein said hollow shell has at least feature to supports said charging device within said mount.

9. The assembly of claim 1, wherein said hollow shell has at least feature to supports said charging device within said mount.

10. The assembly of claim 9, wherein said feature further comprises as least one rail formed on said assembly that allows said assembly to be slid into said mount.

11. The assembly of claim 10, wherein said rail is formed on said outer shell.

12. The assembly of claim 11, wherein said hollow shell has a plurality of tabs that provide location assistance of said assembly within said mount.

13. The assembly of claim 12, wherein said mount has at least one slot that mates with said rail.

14. The assembly of claim 1, wherein said mount further comprises a fastening mechanism that engages said assembly within said mount.

15. The assembly of claim 14, wherein said fastening mechanism within said mount removeably secure said assembly to said mount.

16. The assembly of claim 15, wherein said fastening mechanism further comprises a spring.

17. An assembly for a charging device comprising:
a shell having at least one attachment portion containing said charging device;
at least one end cover for said shell;
a frame having at least features that mates with said attachment portion to said shell; and
an attachment mechanism that removeably secures said assembly to said frame in a predetermined position/

18. The assembly claiml7, wherein said shell further comprises an insulative outer shell.

19. The assembly 17 wherein said shell in conductive.

20. The assembly of claim 17 wherein said assembly further comprises a ground plane.
